(19) United States
(12) Patent Application Publication
(10) Pub. No.: US 2025/0143458 A1
(43) Pub. Date: May 8, 2025

(54) SIDEWALL IN THE FORM OF A CONTAINER SIDEWALL, IN PARTICULAR A DRAWER SIDEWALL

(71) Applicant: Julius Blum GmbH, Hoechst (AT)

(72) Inventors: Gerald SPERGER, Hard (AT); Claudio GMEINER, Alberschwende (AT); Michael RAFFEINER, Hard (AT)

(21) Appl. No.: 19/014,885

(22) Filed: Jan. 9, 2025

Related U.S. Application Data
(63) Continuation of application No. PCT/AT2023/060220, filed on Jul. 6, 2023.

(30) Foreign Application Priority Data
Jul. 21, 2022 (AT) A 50552/2022

(51) Int. Cl. A47B 88/90; A47B 88/95

(52) U.S. Cl. CPC A47B 88/941; A47B 88/95; A47B 2088/902

(57) ABSTRACT

The invention relates to a side panel in the form of a container side wall, in particular a drawer side wall, including a rear wall holder and/or a front wall holder and a preferably one-piece, bent sheet profile in the form of a panel hat for receiving the rear wall holder and/or the front wall holder. The rear wall holder and/or the front wall holder is arranged at least partially within the sheet profile, and the sheet profile is collared to the front wall holder and/or to the rear wall holder at at least one connection point by a collar.

The present application is a continuation of International Application PCT/AT2023/060220 filed on Jul. 6, 2023. Thus, all of the subject matter of International Application PCT/AT2023/060220 is incorporated herein by reference.

### BACKGROUND OF THE INVENTION

The invention relates to a side panel in the form of a container side wall, in particular a drawer side wall, comprising at least one rear wall holder and/or at least one front wall holder and a, preferably one-piece, bent sheet profile in the form of a panel hat for receiving at least one rear wall holder and/or at least one front wall holder, wherein the at least one rear wall holder and/or the at least one front wall holder is arranged at least partially within the sheet profile. Furthermore, the invention relates to an arrangement comprising at least one body rail with a lateral web for connecting the at least one body rail to a furniture body, at least one, in particular cuboid-shaped, drawer rail with a further lateral web oriented substantially parallel to the lateral web in the state of use of the arrangement, and at least one such side panel. Furthermore, the invention relates to a piece of furniture, in particular a drawer, with at least one furniture body and at least one such side panel. The invention further relates to a method for producing such a side panel.

Such a side panel is already known from the prior art, in which a rear wall holder with a sheet profile is screwed together with a container rail.

A disadvantage of the prior art is that the screw connection of the rear wall holder requires additional components and entails increased assembly effort. If the screw connection is not properly fastened, for example, an undesirable force transmission occurs between the rear wall holder and the side panel, which can result in a reduced service life of the side panel. In addition, holes must be drilled into the sheet part, wherein there is a risk of tension within the side panel due to tolerances and a high degree of accuracy of the holes in the sheet part is required in order not to impair the visual appearance of the side panel. In addition, screw connections pose the risk of collision with other components of the side panel and require installation space within the side panel. However, a firm connection between the rear wall holder and the side panel is essential when using the side panel.

### SUMMARY OF THE INVENTION

The object of the present invention is therefore to provide a side panel, an arrangement, a piece of furniture and a method for producing such a side panel which are improved compared to the prior art, in which the disadvantages of the prior art are at least partially eliminated and which are characterized in particular by an efficient production process, a reduced number of component parts, a compact side panel and/or a particularly strong connection between the rear wall holder and/or front wall holder and the sheet part.

Therefore, according to the invention, the sheet profile is collared to the at least one front wall holder and/or to the at least one rear wall holder at at least one connection point by at least one collar. This makes it possible to avoid the need for a screw, rivet, weld or nail connection—which is usually used in the prior art. By means of the at least one collar, a frictional connection in the direction of the at least one collar—generally along a collar opening of the at least one rear wall holder or the at least one front wall holder—and/or a form-fitting connection in the orthogonal direction thereto can be formed.

The at least one collar has proven to be a particularly favorable connection for the side panel, wherein, in particular in the case of a metallic sheet profile and a plastic-like front wall holder and/or plastic-like rear wall holder, a secure relative positioning within the sheet profile can be ensured—without the need for separate connecting means or fastening means.

In general, in the case of the at least one collar, a material of the sheet profile is pressed by a punch or the like onto an opening—in particular the outer surface of the opening—of the at least one front wall holder and/or the at least one rear wall holder via plastic deformation. The sheet profile is generally drilled through by the punch, although this is not mandatory.

Another positive feature is that no container rail is required to increase sufficient stability of the side panel and to ensure a connection to a drawer rail.

In addition, the collars generally do not protrude from the sheet profile, so that a flat plane can be formed on the underside of the sheet profile and/or the collars can be arranged on the side surface of the sheet profile within a profiling, so that a flat plane can be created which can be covered by a container base.

The technical term “panel hat” is to be interpreted in such a way that it defines a curved sheet profile for forming a container side wall. Curved is to be interpreted broadly enough to also include sheet parts connected to one another by means of a material bond or fastening means, away from a container rail. Particularly preferably, the sheet profile is open in regions downwards in the state of use and/or is closed downwards by the at least one front wall holder and/or the at least one rear wall holder.

As stated at the outset, protection is also sought for an arrangement comprising at least one body rail with a lateral web for connecting the at least one body rail to a furniture body, at least one, in particular cuboid-shaped, drawer rail with a further lateral web oriented substantially parallel to the lateral web in the use state of the arrangement, and at least one such side panel, wherein the at least one side panel is mounted displaceably relative to the at least one body rail via the at least one drawer rail.

In general, a middle rail for full extension of a container can be provided between the at least one drawer rail and the at least one body rail, although this is generally not necessary.

The state of use of the arrangement can be defined by the position of the arrangement on a furniture body, wherein in the state of use the arrangement is prepared in such a way that a container base, a container front and/or a container rear wall can be fastened to the arrangement to form a container such as a drawer without further assembly steps (such as mounting a container rail). The term vertically from above therefore defines a degree of freedom orthogonal to a longitudinal extension of the at least one side panel in the direction of gravity on a contact surface of the at least one drawer rail for the container base.

Particularly advantageous in the arrangement is the transmission of force between the at least one drawer rail and the at least one side panel and/or within the at least one side panel. In the prior art, when the arrangement is loaded, a force is transmitted via the container rail (on which the container base rests) arranged for coupling to the drawer rail and the side panel, which results in an unstable indirect connection. In the arrangement, an arrangement with increased strength/stability can be provided by omitting the container rail, since a force flow between the at least one drawer rail and the at least one side panel (as well as within the at least one side panel) is particularly facilitated and in particular deformations such as swelling, bending and the like are inhibited (in particular by a direct coupling with the container base on the sheet profile).

There is no need for manufacturing or assembling a container rail or using fastening materials such as screws for the side panel. The at least one front wall holder and/or the at least one rear wall holder preferably comprise fastening means and/or openings for fastening means for a container front and/or a container rear wall, wherein the fastening means can be in the form of clamping devices, for example—particularly preferably for wooden panels.

As stated at the outset, protection is also sought for a piece of furniture, in particular a drawer, with at least one furniture body and at least one such side panel, preferably at least one such arrangement.

The terms container base, container rear wall, container front and the like are used below to define preferred component parts of a drawer which, as a container, forms a piece of furniture together with a furniture body.

As stated at the outset, protection is also sought for a method for producing such a side panel, wherein the following steps are carried out, in particular in chronological order: The sheet profile and the at least one front wall holder and/or the at least one rear wall holder are provided, wherein the at least one front wall holder and/or the at least one rear wall holder and optionally at least one stabilizing element are inserted into the sheet profile of the side panel (1), and the sheet profile is collared to the at least one front wall holder and/or to the at least one rear wall holder at at least one connection point by at least one collar.

Conventionally, a side panel is connected to a container rail and/or a front wall holder or a rear wall holder via welds and/or fastening means such as rivets, screws or the like. Due to the at least one collar, no additional components are required, the service life of the side panel can be increased, a stable side panel can be achieved and assembly and manufacturing costs can be reduced.

The features of the device claims are applicable to the method claims and vice versa.

Advantageously, the sheet profile is connected to the at least one front wall holder and/or to the at least one rear wall holder at multiple connection points by a collar. By increasing the number of collars, a secure connection can be ensured despite high loads on the side panel.

It has proven to be advantageous that the at least one collar is arranged on a side surface (as a component with two side planes aligned substantially parallel and/or spaced apart from one another by a material thickness) of the sheet profile, preferably facing a drawer rail and/or a container base in a state of use of the side panel, and/or on an underside of the sheet profile located in a state of use of the side panel, preferably adjacent to the side surface.

If the at least one collar is arranged only on one side of the side panel, the aesthetic appearance of the side panel is improved. If the at least one collar is present on two sides of the side panel, a particularly strong connection with the sheet profile can be achieved and/or a defined relative positioning of the at least one front wall holder/rear wall holder on the sheet profile—in three bidirectional spatial directions—can be achieved.

According to an advantageous embodiment of the invention, the at least one front wall holder and/or the at least one rear wall holder is formed essentially from plastic, and the at least one collar is present between the plastic and metal of the sheet profile. Preferably, the at least one front wall holder and/or the at least one rear wall holder comprises at least one connecting means for a container front and/or a container rear wall, particularly preferably made of metal. The at least one connecting means can be in the form of a furniture fitting, a screw connection or the like, for example.

It has proven to be advantageous that the at least one collar has a substantially circular cross-section and/or the at least one collar extends completely over a material thickness of the sheet profile and/or the at least one collar is formed by material of the sheet profile in contact with material of the at least one front wall holder and/or the at least one rear wall holder.

As a result, a particularly strong connection can be generated between the sheet profile and the at least one front wall holder and/or the at least one front wall holder, wherein metallic material of the sheet profile is pressed onto plastic-like material of the at least one front wall holder and/or the at least one front wall holder.

An advantageous variant consists in that the at least one collar extends at least partially into at least one collar opening of the at least one front wall holder and/or the at least one rear wall holder, wherein it is preferably provided that a depth of the at least one collar is between 5% and 80%, particularly preferably between 10% and 50%, further particularly preferably between 20% and 30%, of a collar opening depth.

By extending the at least one collar within the at least one front wall holder and/or the at least one rear wall holder, a connection strength to the sheet profile can be adjusted. The collar opening can, for example, be in the form of a hole. In general, a recess can also be created during an injection molding process—for example, by a core.

It is particularly preferred that the sheet profile comprises a groove-shaped profiling on a side surface of the sheet profile, preferably with a substantially rectangular cross-section, which is designed to receive a container base.

The profiling can, for example, be introduced into the sheet profile in the form of bends. Due to the profiling, the container base can be connected directly to the at least one side panel, wherein the profiling can represent a support for the container base, so that in particular no indirect connection between the side panel and the container base via a container rail is required.

In one embodiment of the invention, the profiling comprises at least one fastening means, preferably in the form of at least one barb, particularly preferably with two prongs, for connecting the container base to the sheet profile and/or for securing the container base to the sheet profile, wherein it is preferably provided that the at least one fastening means is materially connected to the sheet profile and/or is punched out of the profiling and/or protrudes transversely into the profiling.

By means of at least one fastening means, an undesirable loosening of a container base arranged on the side panel—and possibly a container rear wall—can be prevented, so that a secure positioning of the container base directly on the side panel can be ensured.

According to a preferred embodiment of the invention, the at least one front wall holder and/or the at least one rear wall holder is designed in the form of a bracket for insertion into the sheet profile, preferably via a recess of the at least one front wall holder and/or the at least one rear wall holder corresponding to an optional profiling of the sheet profile.

The bracket can be provided as a component in a plane with the longitudinal extension of the at least one side panel and/or orthogonal to a plane of the longitudinal extension of the at least one side panel. This makes it possible to save material and/or increase the stability of the at least one side panel and/or increase the stability of a container with the arrangement.

Preferably, the at least one front wall holder and/or the at least one rear wall holder comprises at least one connecting means such as a screw and/or at least one opening for arranging at least one connecting means such as a screw.

It has proven to be advantageous that at least one stabilizing element is provided, which is arranged, preferably in the longitudinal extension of the side panel centrally and/or completely, at least in regions within the sheet profile to increase the rigidity and/or strength of the side panel. Preferably, the at least one stabilizing element can be inserted into the sheet profile via a recess of the at least one stabilizing element corresponding to an optional profiling of the sheet profile.

By means of the at least one stabilizing element, the shape accuracy of the side panel under load—especially in the case of long side panels—can be increased, wherein undesirable deformations of the side panel can be reduced. The recess facilitates assembly of the at least one stabilizing element and promotes proper positioning relative to the at least one side panel.

Furthermore, preferably a width of the sheet profile is between 3 mm and 10 mm, preferably between 4 mm and 6 mm.

According to the invention, a lateral expansion of the sheet profile can be reduced compared to side panels with container rails, since the container rail and separate connecting means such as screw connections can be dispensed with. This makes it possible to achieve a particularly compact arrangement, wherein, for example, more storage space can be generated in a container with such an arrangement or a narrower container can be formed with the same storage space.

In a further embodiment, the at least one front wall holder and/or the sheet profile comprises at least one coupling device for direct coupling to a drawer rail, preferably without container rail.

If the at least one coupling device is arranged directly on the front wall holder or the sheet profile, an indirect connection to the at least one drawer rail via a container rail can be dispensed with. A force transmission between the at least one side panel and the at least one drawer rail is thereby carried out in an advantageous manner.

According to an advantageous embodiment of the invention, the at least one side panel, preferably the side surface of the sheet profile, in a state fastened to the at least one drawer rail is arranged at least partially directly between the lateral web and the further lateral web.

This makes it possible to completely dispense with a container rail, which acts as a connecting link between the at least one side panel and the drawer rail. The at least one side panel—in particular the side surface of the sheet profile—can act, due to the relative positioning between the at least one body rail and the at least one drawer rail, both for the direct connection of a container base and (for example via the at least one front fitting) for the direct coupling with the drawer rail.

In addition to the manufacturing and assembly improvements such as material savings, component reduction, reduced assembly effort, cost savings, etc., there is the positive feature that the at least one drawer rail is not covered at the top by a container rail when in use, so that the at least one drawer rail can serve as a support for the container base.

The side surface as an integral part of the sheet profile, which faces the at least one drawer rail, generally represents that side surface which is arranged substantially parallel to a side surface facing the at least one body rail (which may generally have a kink, for example).

The wording “direct” can be interpreted as a synonym for the term “immediate”, in other words no container rail is arranged on the sheet profile of the at least one side panel. This means that starting from the web and/or the further web no container rail but the sheet profile is positioned, in the orthogonal direction, on the web and/or the further web.

The side surface as an integral part of the sheet profile, which faces the at least one drawer rail, generally represents that side surface which is arranged substantially parallel to a side surface facing the at least one body rail (which may generally have a kink, for example).

According to an advantageous embodiment of the invention, the at least one drawer rail comprises a support surface which is aligned substantially orthogonally to the further lateral web and preferably adjoins the further lateral web for directly supporting a container base in the use state of the arrangement, wherein it is preferably provided that the support surface is freely accessible in the use state of the arrangement in the vertical direction from above, particularly preferably at least in regions and/or in the region of a contact area for the container base.

In the prior art, the container base rests on the container rail. Thanks to the support surface of the drawer rail, the container rail can be dispensed with and the container base can be supported particularly stably on at least one drawer rail.

Advantageously, exactly one sheet profile is provided for direct connection to the drawer rail and/or a container base. Preferably, the exactly one sheet profile is formed exclusively by the panel hat—in particular without a container rail.

It has proven to be advantageous that the at least one side panel is coupled to the at least one drawer rail directly by contact, preferably without a container rail, by at least one coupling device of the sheet profile and/or the at least one front wall holder.

If the at least one coupling device is arranged directly on the front wall holder or the sheet profile, an indirect connection to the at least one drawer rail via a container rail can be dispensed with. A force transmission between the at least one side panel and the at least one drawer rail is thereby carried out in an advantageous manner.

According to an advantageous embodiment of the invention, the arrangement comprises at least one container base, which contacts the sheet profile directly, preferably without container rails and/or via a groove-shaped profiling of a side surface of the sheet profile for receiving the at least one container base, wherein it is preferably provided that the at least one container base is secured to the sheet profile via at least one fastening means.

In the prior art, the container base rests on the container rail in a narrow contact region and is arranged without contact with the side panel, wherein the direct contact of the at least one container base with the at least one side panel means that the container rail can be dispensed with and, in addition, a simplified, secure and/or stable connection of the at least one container base can be ensured.

It has proven to be advantageous that the at least one container base is arranged substantially flush with the at least one drawer rail, wherein it is preferably provided that the at least one container base rests flat on the at least one drawer rail.

If the at least one container base rests flat on the at least one drawer rail, an undesirable bending of the at least one container base can be counteracted by the support for the at least one container base formed via the at least one drawer rail. In general, the at least one container base can also be arranged with clearance relative to the at least one drawer rail, wherein, for example, contact is only made when the arrangement is loaded.

An advantageous variant consists in that the arrangement comprises at least one container rear wall, which is arranged on the at least one rear wall holder.

Preferably, a force transmission in the event of a preferably vertical and/or lateral loading of the arrangement in a state of use of the arrangement can be provided directly, preferably without container rails, between the at least one side panel, preferably the sheet profile and/or the at least one front wall holder and/or the at least one rear wall holder, and the at least one drawer rail.

Since the container rail can be dispensed with, a lifetime-extending force flow within the at least one side panel and/or between the at least one side panel and the at least one drawer rail is made possible when the arrangement is loaded.

Particularly preferably, in a preparatory method step, at least one collar opening is introduced into the at least one front wall holder and/or the at least one rear wall holder, wherein the at least one collar is formed between a plastic of the at least one front wall holder and/or the at least one rear wall holder and a metal of the sheet profile, preferably with a substantially circular cross-section, wherein the at least one collar extends at least partially in the at least one collar opening of the at least one front wall holder and/or the at least one rear wall holder.

It is preferred that the at least one collar is introduced, preferably automatically, by at least one punch or pin, wherein it is preferably provided that the sheet profile is collared to the at least one front wall holder and/or to the at least one rear wall holder at multiple connection points by a collar, particularly preferably arranged on a side surface of the sheet profile and/or on an underside of the sheet profile located in a state of use of the side panel. This reduces the production effort required to form the side panel, allowing for a particularly efficient production process.

Preferably, the punch has a, preferably conical taper at a free end and/or comprises a diameter which essentially corresponds to an extension of the collar opening minus twice the material thickness of the sheet profile.

According to a preferred embodiment, material of the sheet profile is pressed against the at least one collar opening, so that a force-fitting connection along the at least one collar opening and/or a form-fitting connection orthogonal to the at least one collar opening is formed. This allows a particularly secure and stable connection to be generated between the sheet profile and at least one front wall holder and/or rear wall holder.

### BRIEF DESCRIPTION OF THE DRAWINGS

Further details and advantages of the present invention will be explained in more detail below with reference to the drawings, in which:

FIGS. 1a, 1b show a side panel according to a preferred embodiment in a perspective exploded view and in a perspective view with mounted front wall holder and rear wall holder,

FIGS. 2a, 2b show the side panel according to the embodiment of FIG. 1b before the insertion of collars on an underside of a sheet profile of a panel hat and with collars already inserted on a side surface of the sheet profile,

FIGS. 3a, 3b show the side panel according to the exemplary embodiment of FIG. 2b during and after the insertion of collars on the underside of the sheet profile in a perspective view,

FIGS. 4a, 4b show the side panel according to the exemplary embodiments according to FIGS. 3a and 3b in a sectional view with enlarged detail in the region of connection points of the collars,

FIGS. 5a-5c show the side panel according to the embodiment of FIG. 3b in a perspective view, a view looking towards the side surface of the sheet profile and looking towards the underside of the sheet profile,

FIGS. 6a, 6b show a side panel according to a further preferred embodiment in a perspective view of varying viewing angles with detail cutouts in the region of collars on the side surface and on the underside of the sheet profile,

FIGS. 7a, 7b show a container in the form of a drawer with a side panel in perspective view from different viewing directions as well as a detailed section in the region of the rear wall holder,

FIGS. 8a, 8b show the side panel according to the exemplary embodiment of FIG. 6a in a perspective exploded view,

FIGS. 9a, 9b show the side panel according to the exemplary embodiment of FIG. 6a during an assembly process in perspective view, and

FIG. 10 shows an arrangement of a side panel, a drawer rail and a body rail in perspective view with an enlarged detailed view in the region of a coupling device between the front wall holder and the drawer rail.

### DETAILED DESCRIPTION OF THE INVENTION

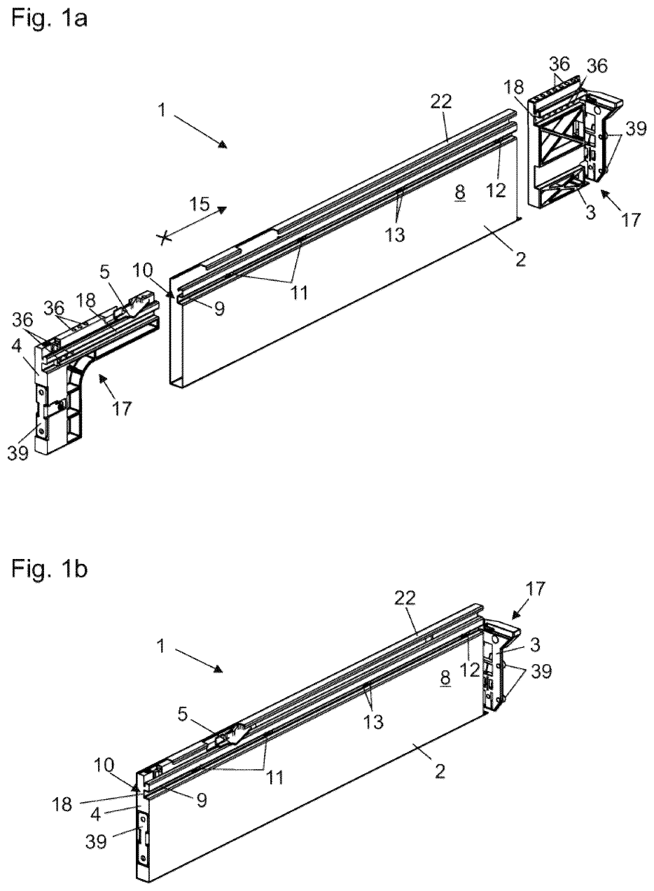

FIG. 1a shows a side panel 1 in the form of a container side wall designed as a drawer side wall in an exploded view.

The side panel 1 comprises a rear wall holder 3, a front wall holder 4 and a one-piece, bent sheet profile 2 in the form of a panel hat for receiving the rear wall holder 3 and the front wall holder 4.

The sheet profile 2 comprises on a side surface 8 of the sheet profile 2 a groove-shaped profiling 9 with a substantially rectangular cross-section 10, which is designed to receive a container base 7.

In the profiling 9, fastening means 11 in the form of barbs 12 with two prongs 13 (the number of prongs 13 is generally arbitrary) are provided for connecting the container base 7 to the sheet profile 2 and for securing the container base 7 to the sheet profile 2. The fastening means 11 are materially connected to the sheet profile 2, punched out of the profiling 9 and protrude transversely into the profiling 9.

The front wall holder 4 and the rear wall holder 3 are in the form of a bracket 17 (in a plane along a longitudinal extension 15 or in a plane orthogonal to the longitudinal extension 15) for insertion into the sheet profile 2 via a recess 18 of the front wall holder 4 and the rear wall holder 3 corresponding to a profiling 9 of the sheet profile 2.

FIG. 1b shows the side panel 1 in a partially assembled state before the insertion of collars for connecting the front wall holder 4 and the rear wall holder 3 to the sheet profile 2, wherein the rear wall holder 3 and the one front wall holder 4 are arranged within the sheet profile 2.

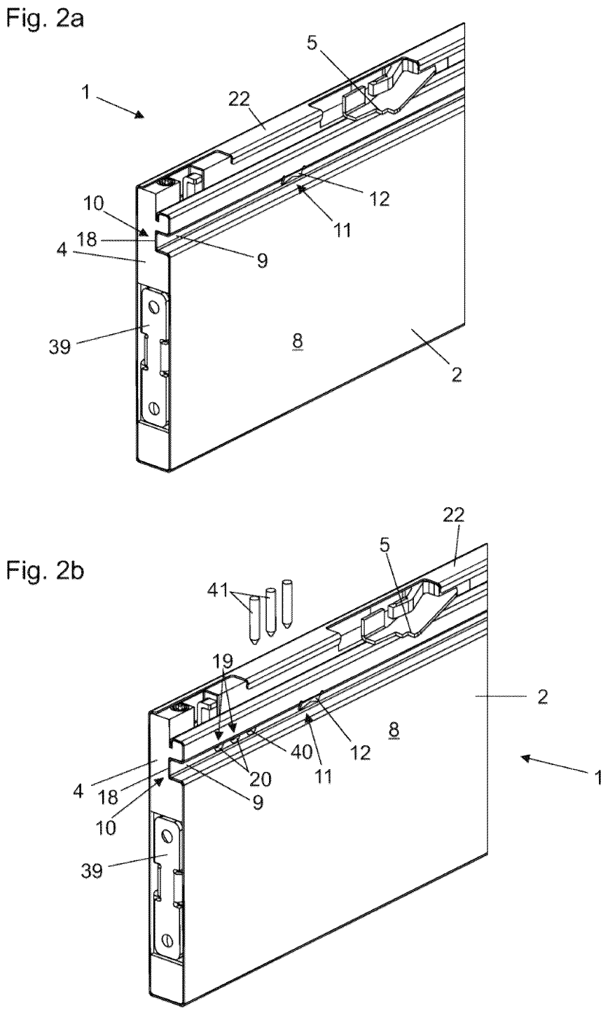

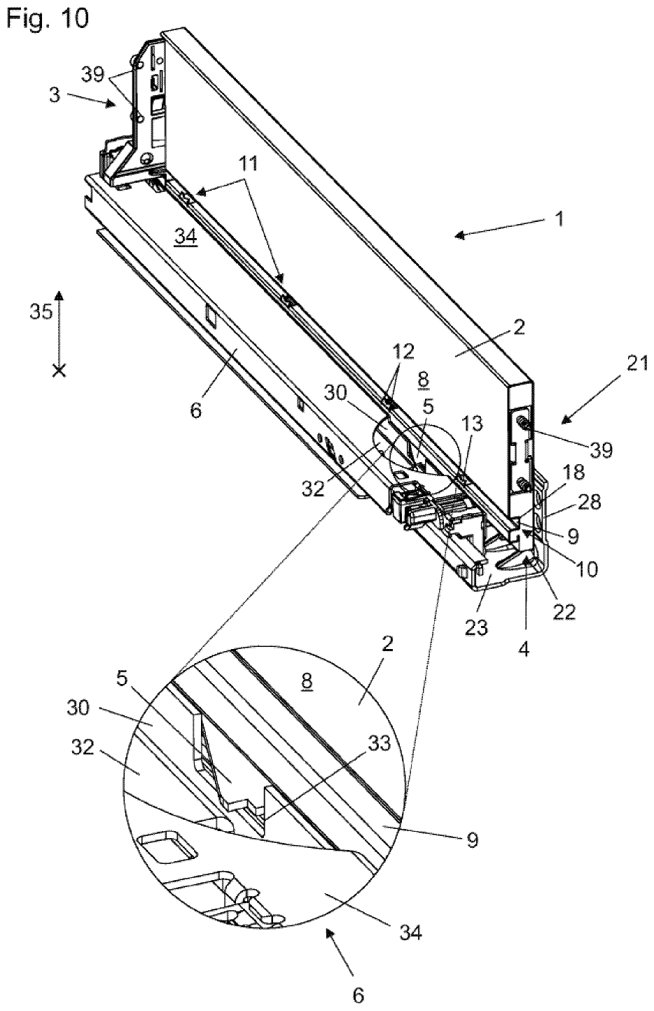

FIG. 2a shows that the front wall holder 4 (generally also conceivable on the sheet profile 2) comprises a coupling device 5 for direct coupling to a drawer rail 6 without the need for a container rail (cf. FIG. 10).

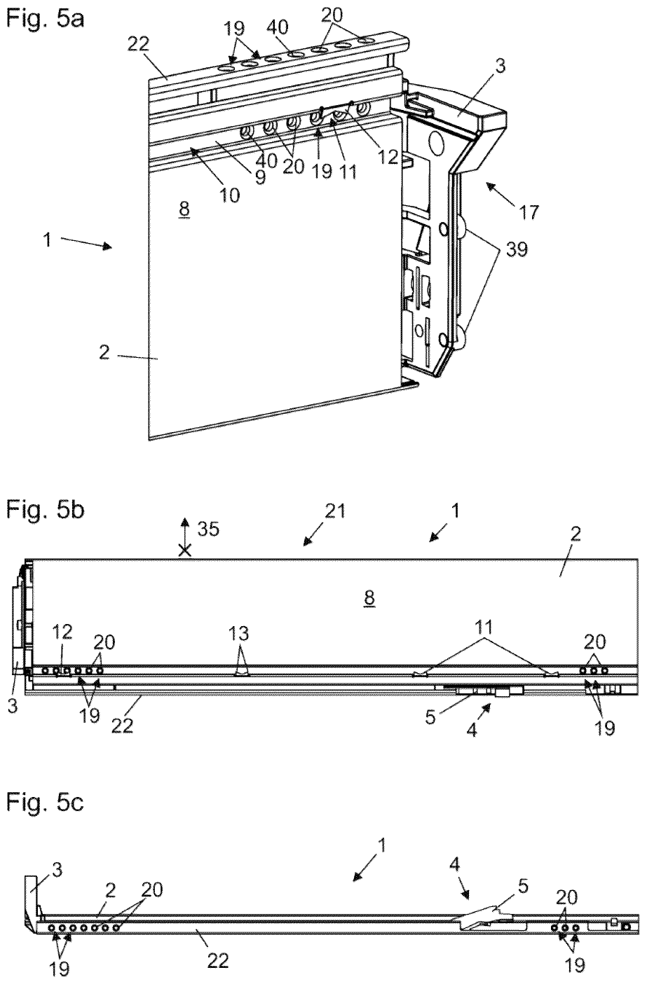

FIG. 2b shows that the sheet profile 2 is already connected to the front wall holder 4 (if necessary also to the rear wall holder 3) at multiple connection points 19 by means of collars 20. The collars are arranged on a side surface 8 of the sheet profile 2 which, in a state of use 21 of the side panel 1, faces a drawer rail 6 or a container base 7 (see FIG. 5b).

Further collars 20 are arranged on an underside 22 (see FIG. 5b) of the sheet profile 2 located in a state of use 21 of the side panel 1 and adjacent to the side surface 8.

The collars 20 are automatically inserted by punches 41, wherein the punches 41 have a conical taper at a free end, with which material of the sheet profile 2 can be pressed onto material of the front wall holder 4 via the collar opening 36.

The front wall holder 4 and the rear wall holder 3 are basically made of plastic, with the collars 20 being present between the plastic and metal of the sheet profile 2. The front wall holder 4 comprises connecting means 39 for a container front 24 made of metal.

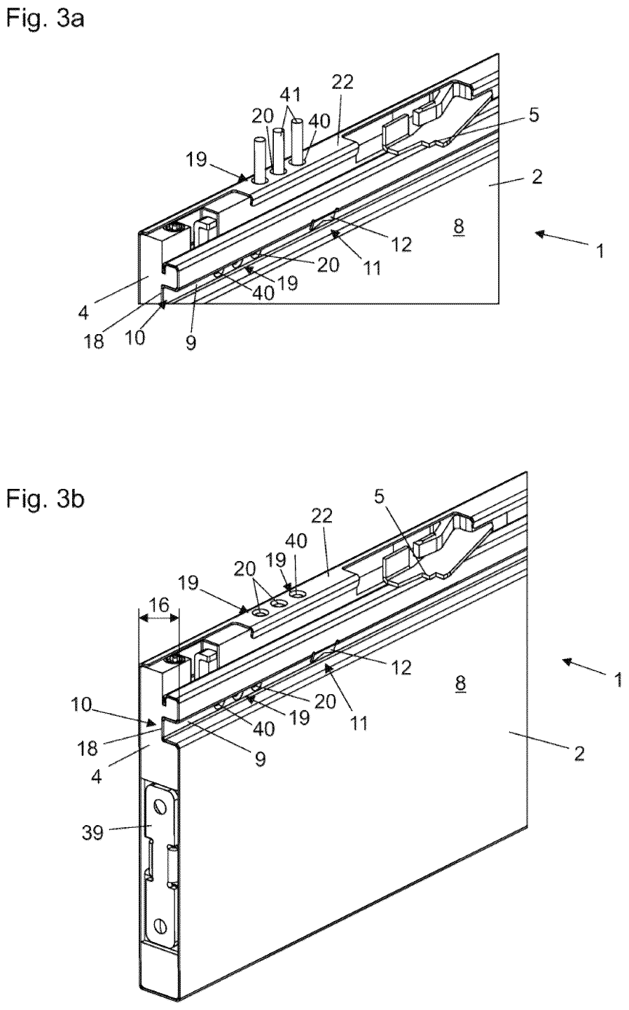

FIG. 3a shows the process step of inserting collars 20 on the underside 22 of the sheet profile 2 in connection with the front wall holder 4.

FIG. 3b shows that the sheet profile 2 has a width 16, wherein the width 16 is between 4 mm and 6 mm. The collars 20 are inserted so that the side panel 1 can be connected directly to a drawer rail 6.

The collars 20 on the underside 22 form a flat underside 22. The collars on the side surface 8 are arranged within the profiling 9 and are covered by the container base 7 after a container base 7 has been connected.

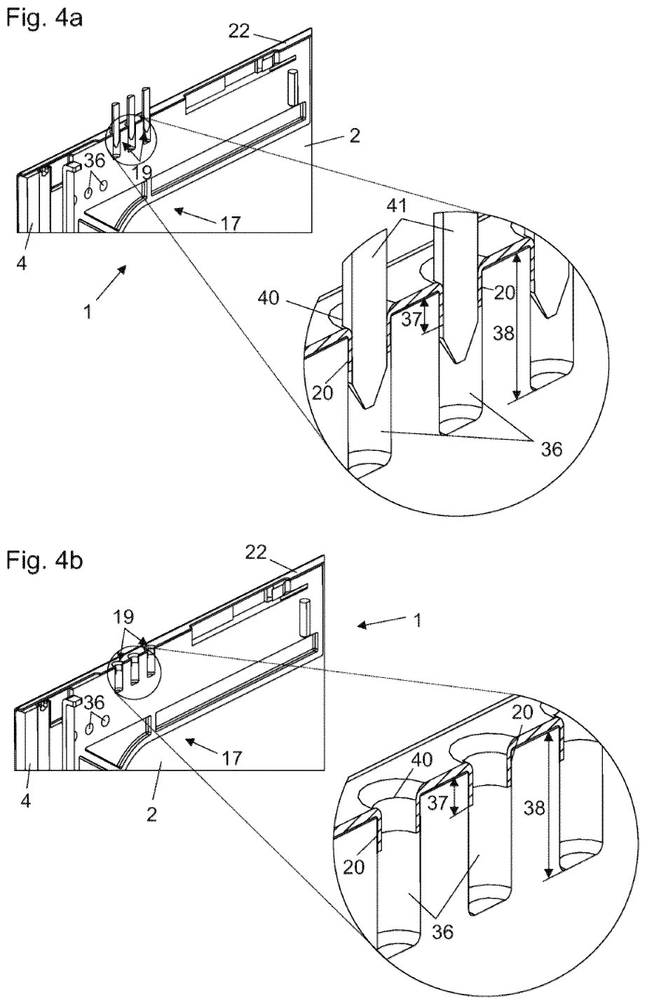

FIG. 4a shows that the collars 20 have a circular cross-section 40 and the collars 20 extend completely over a material thickness of the sheet profile 2 and are formed by material of the sheet profile 2 in contact with material of the front wall holder 4—or the rear wall holder 3—.

FIG. 4b differs from FIG. 4a only in that punches 41 have already been removed from the collar openings 36.

The collars 20 extend in regions into and beyond the collar openings 36 of the front wall holder 4 (or the rear wall holder 3).

A depth 37 of the collars 20 is between 10% and 50% of a collar opening depth 38.

FIG. 5a shows an enlarged detail of the side panel 1 in the region of the rear wall holder 3.

A method for producing the side panel 1 can be exemplified as follows (without any mandatory chronological relation):
the sheet profile 2, the front wall holder 4 and the rear wall holder 3 are provided, wherein the front wall holder 4 and the rear wall holder 3 (if necessary with a stabilizing element 14) are inserted into the sheet profile 2 of the side panel 1
at least one collar opening 20 is introduced into the front wall holder 4 or the rear wall holder 3
the sheet profile 2 is collared to the front wall holder 4 and the rear wall holder 3 at at least one connection point 19 by a collar 20, wherein the collar 20 is formed between a plastic of the front wall holder 4 or the rear wall holder 3 and metal of the sheet profile 2 and the collar 20 extends in regions into the collar opening 36 of the front wall holder 4 or the rear wall holder 3 and beyond.

FIG. 5b shows that the collars 20 have a circular cross-section 40 and are each arranged at an end region of the sheet profile 2.

FIG. 5c differs from FIG. 5b only in that the side panel 1 is shown from the underside 22.

Material of the sheet profile 2 is pressed against the collar opening 36 in such a way that a force-fitting connection along the collar opening 36 and a form-fitting connection orthogonal to the collar opening is present.

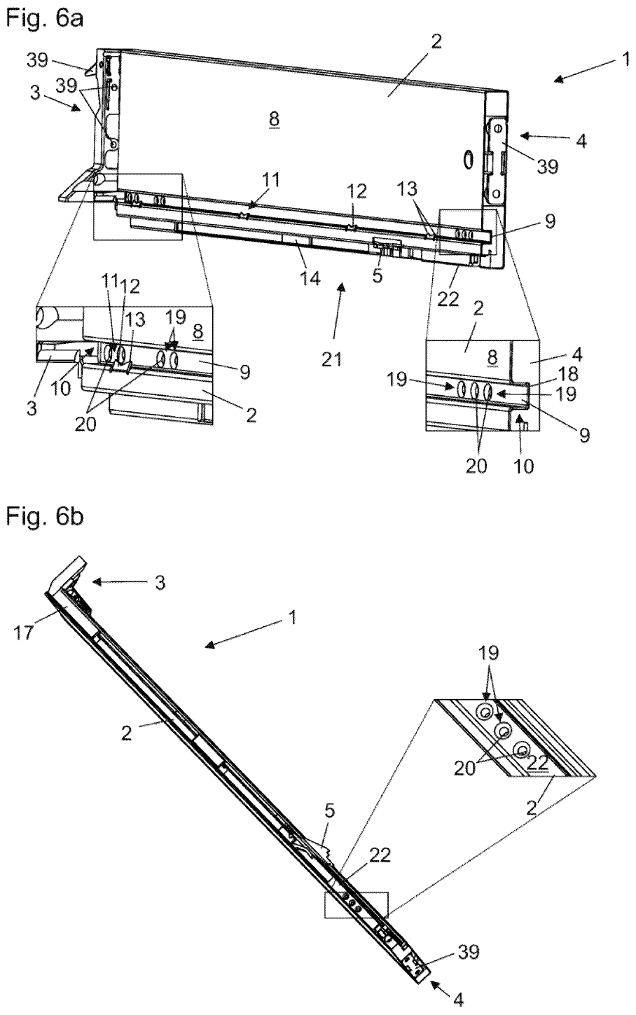

FIG. 6a shows that the rear wall holder 3 comprises connecting means 39 for a container rear wall 25, wherein the connecting means 39 are in the form of a clamping means that can be pressed against the container rear wall 25 and in the form of openings for fastening means such as screws. In general, only a clamping means or openings may be provided.

The side panel 1 is in a fully assembled state, wherein the side panel 1 is ready to be connected directly to a drawer rail 6 or a container base 7.

The sheet profile 2 is connected to the front wall holder 4 and to the rear wall holder 3 at multiple connection points 19, wherein the number of connection points 19 is generally arbitrary.

Collars 20 are arranged on the side surface 8 of the sheet profile 2 within the profiling 9, although this is not mandatory.

FIG. 6b differs from FIG. 3a only in that the side panel 1 is shown in a different viewing direction.

Collars 20 are arranged on an underside 22 of the sheet profile 2 located in a state of use 21 of the side panel 1. In general, it is possible to provide a collar only on the side surface 8 or the underside 22.

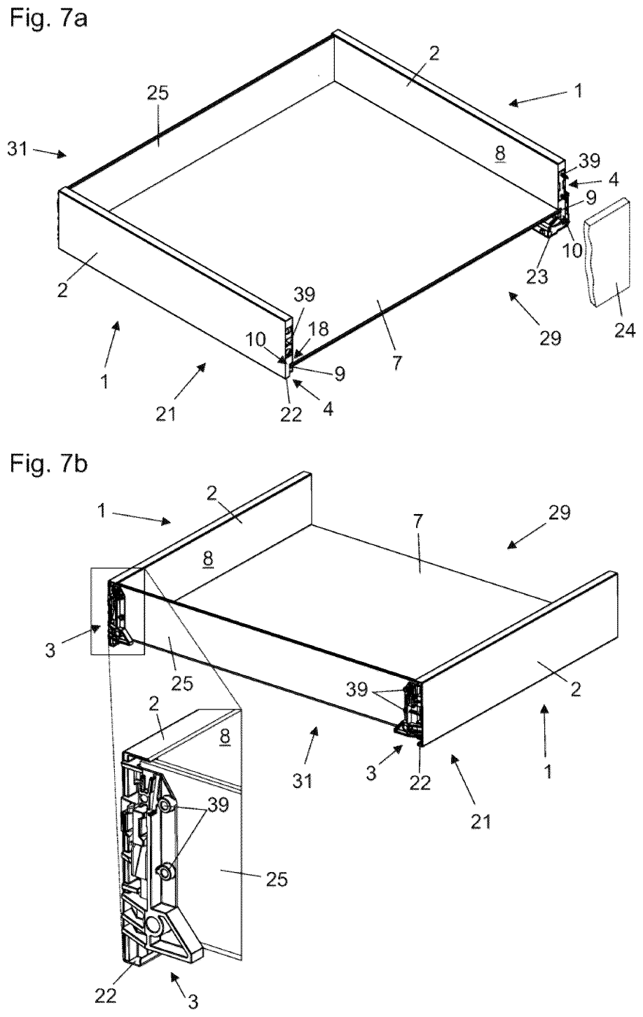

FIG. 7a shows a container 29 in the form of a drawer 31 for a piece of furniture with a furniture body (not shown in the illustration for reasons of clarity) and at least one arrangement of side panel 1, drawer rail 6 and body rail 23, wherein the drawer rail 6 is covered by the container base 7.

The container base 7 contacts the sheet profile 2 directly and without a container rail via the groove-shaped profiling 9 of the side surface 8 of the sheet profile 2 for receiving the container base 7. The container base 7 is secured to the sheet profile 2 via the fastening means 11, wherein exactly one sheet profile 2 is provided for the direct connection to the drawer rail 6 and the container base 7.

The collars 20 support the assembly process of the container 29 due to their structural dimensions.

A container front 24 is indicated schematically in dashed lines.

The container base 7 is arranged flush with the drawer rail 6, wherein the container base 7 rests flat on the drawer rail 6.

FIG. 7b differs from FIG. 4a only in that it is viewed from a different angle. In the enlarged detail it can be seen that the container rear wall 25 is arranged on the rear wall holder 3.

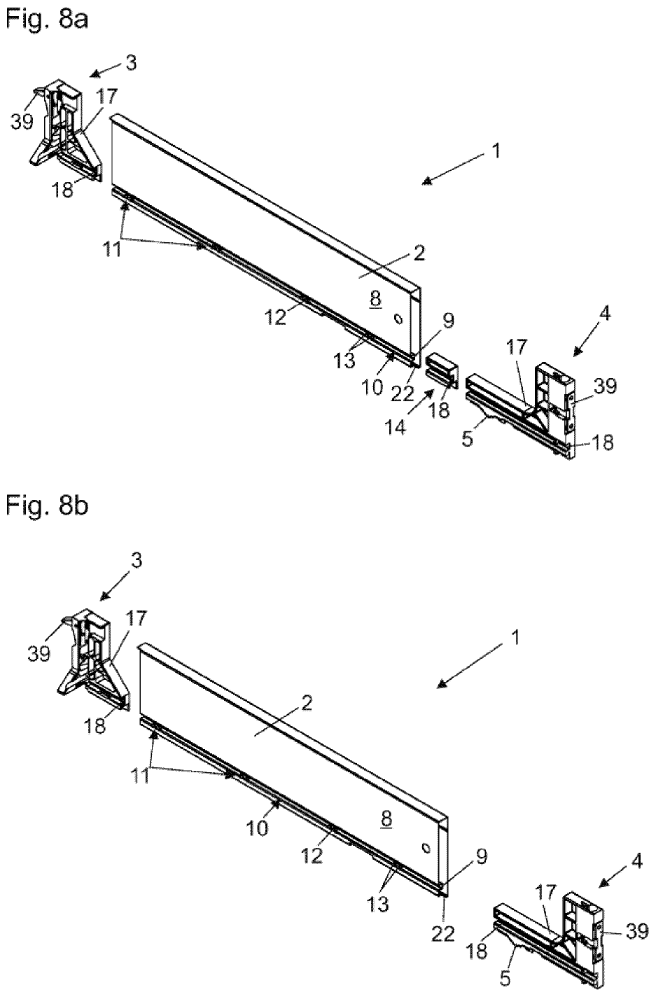

FIG. 8a and FIG. 8b show side panels 1 in the form of a container side wall designed as a drawer side wall in a dismantled state for direct connection to a container base 7 and a drawer rail 6 (see FIG. 10).

In FIG. 8a, the side panel comprises a panel hat—formed from a one-piece bent sheet profile 2—for receiving a rear wall holder 3 and a front wall holder 4, wherein the front wall holder 4 is adapted to be connected to a container front 24, and the rear wall holder 3 is adapted to be connected to a container rear wall 25.

The front wall holder 4 of the side panel 1 comprises a coupling device 5 for direct coupling with the drawer rail 6 without the need for a container rail. In general, it is possible that the coupling device 5 is arranged alternatively or in addition to the sheet profile 2, wherein it is provided that no indirect coupling takes place between the drawer rail 6 and the side panel 1 via a container rail arranged between the side panel and the drawer rail 6.

The side panel 1 comprises a stabilizing element 14, which can be arranged in the longitudinal extension 15 of the side panel 1 in the middle within the sheet profile 2 in order to increase the rigidity and strength of the side panel 1. In general, the stabilizing element 14 can also be dispensed with—in particular in the case of short longitudinal extensions 15 of the side panel 1.

The sheet profile 2 has on a side surface 8 of the sheet profile 2 a groove-shaped profiling 9 with a substantially rectangular cross-section 10, which is designed to receive a container base 7 (see FIG. 7a).

The stabilizing element 14 can be inserted into the sheet profile 2 via a recess 18 of the stabilizing element 14 corresponding to the profiling 9 of the sheet profile 2.

FIG. 8b shows a side panel 1 without a stabilizing element 14, which can be used, for example, for low loads or small longitudinal extensions 15.

Multiple fastening means 11 are arranged in the profiling 9, wherein the number of fastening means 11 is generally arbitrary. The fastening means 11 are in the form of barbs 12, wherein the barbs 12 each have two prongs 13 and the fastening means 11 are suitable for connecting the container base 7 to the sheet profile 2 and for securing the container base 7 to the sheet profile 2. The barbs 12 can also be designed differently.

The fastening means 11 are materially connected to the sheet profile 2, punched out of the profiling 9 and protrude transversely into the profiling 9.

The front wall holder 4 and the rear wall holder 3 are made of plastic, wherein fastening means for a container rear wall 25 or a container front 24 are made of metal.

The front wall holder 4 and the rear wall holder 3 are designed in the form of a bracket 17 (if necessary in two orthogonal spatial directions) for insertion into the sheet profile 2 via a recess 18 of the front wall holder 4 and the rear wall holder 3 corresponding to the profiling 9 of the sheet profile 2.

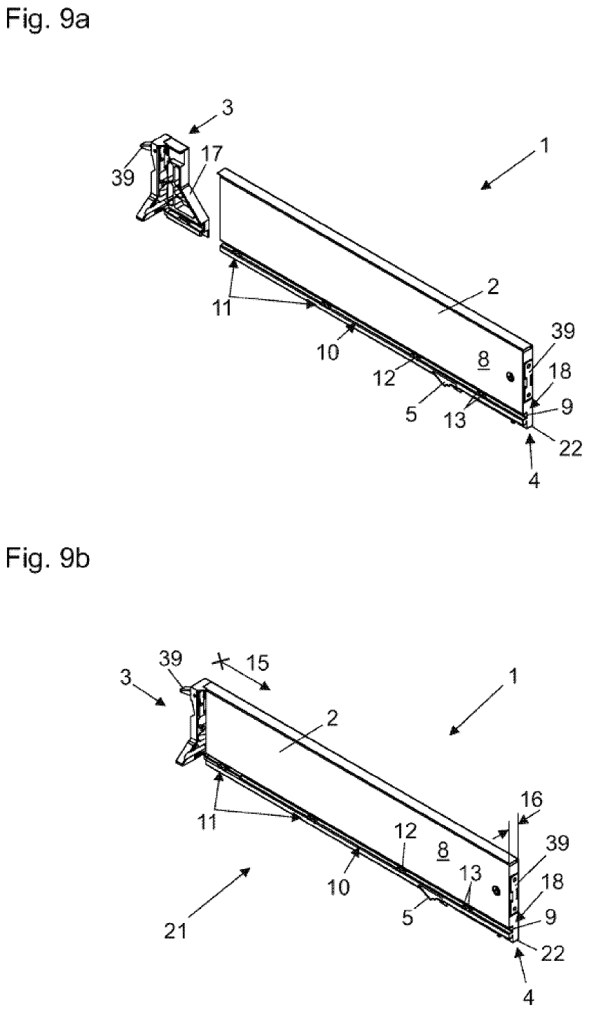

FIG. 9a shows the side panel 1 during the assembly process, wherein the front wall holder 4 has already been inserted into the sheet profile 2.

FIG. 9b differs from FIG. 9a only in that the rear wall holder 3 was also inserted into the sheet profile 2 of the side panel 1 during an assembly step.

A width 16 of the sheet profile 2 is between 4 mm and 6 mm.

FIG. 10 shows an arrangement of the body rail 23 with a lateral web 28 for connecting the body rail 23 to a furniture body, a cuboid-shaped drawer rail 6 with a further lateral web 30 oriented parallel to the lateral web 28 in the use state 21 of the arrangement and at least one side panel 1 in the form of the container side wall designed as a drawer side wall.

The drawer rail 6 comprises a support surface 34 aligned orthogonally to the further lateral web 30 and adjacent to the further lateral web 30 for directly supporting the container base 7 in the use state 21 of the arrangement. In the use state 21 of the arrangement, the support surface 34 is freely accessible in the vertical direction 35 from above and in particular in the region of a contact area for the container base 7.

By means of the coupling device 5, the side panel 1 is coupled directly to the drawer rail 6 by contact and without a container rail.

The side panel 1 is mounted via the drawer rail 6 so as to be displaceable relative to the at least one body rail 23, wherein a middle rail 32 is provided to ensure full extension of the drawer 31. However, the middle rail 32 is generally not mandatory.

The side panel comprises the front wall holder 4 for connecting the container front 24, the rear wall holder 3 for connecting the container rear wall 25 and the one-piece, bent sheet profile 2 in the form of a panel hat for receiving the rear wall holder 3 and the front wall holder 4, wherein the front wall holder 4 is completely arranged and the rear wall holder 3 is partially arranged within the sheet profile 2.

The side surface 8 of the sheet profile 2 of the side panel 1 facing the arrangement of the drawer rail 6 in the use state 21 is arranged in the state fastened to the drawer rail 6 in some regions directly between the lateral web 28 and the further lateral web 30—in an orthogonal direction to the lateral web 28 or the further lateral web 30.

In the detailed section, the coupling between the side panel 1 and the drawer rail 6 is shown enlarged, wherein the coupling device 5 of the front wall holder 4 (or optionally of the sheet profile 2) engages in a coupling device 33 corresponding to the coupling device 5 in the form of a recess or groove in the drawer rail 6.

The coupling device 5 comprises a stepped contour which facilitates a coupling process or a decoupling process between the side panel 1 and the drawer rail 6.

The side panel 1 is arranged directly between the lateral web 28 of the body rail 23 for connecting the body rail 23 to the container 29 and the further lateral web 30 of the drawer rail 6 arranged parallel thereto.

A force transmission in the event of vertical or lateral loading of the arrangement in the use state 21 of the arrangement can be provided directly and without container rails between the side panel 1 and the drawer rail 6.

1. A side panel in the form of a container side wall, in particular a drawer side wall, comprising:
at least one rear wall holder and/or at least one front wall holder, and
a, preferably one-piece, bent sheet profile in the form of a panel hat for receiving at least one rear wall holder and/or at least one front wall holder, wherein the at least one rear wall holder and/or the at least one front wall holder is arranged at least in regions within the sheet profile,
wherein the sheet profile is collared to the at least one front wall holder and/or to the at least one rear wall holder at at least one connection point by means of at least one collar.

2. The side panel according to claim 1, wherein the sheet profile is connected to the at least one front wall holder and/or to the at least one rear wall holder at multiple connection points by a collar.

3. The side panel according to claim 1, wherein the at least one collar is arranged on a side surface of the sheet profile, preferably facing a drawer rail and/or a container base in a state of use of the side panel, and/or on an underside of the sheet profile located in a state of use of the side panel, preferably adjacent to the side surface.

4. The side panel according to claim 1, wherein the at least one front wall holder and/or the at least one rear wall holder is essentially made of plastic, wherein the at least one collar is present between the plastic and metal of the sheet metal profile, wherein it is preferably provided that the at least one front wall holder and/or the at least one rear wall holder comprises at least one connecting means for a container front and/or a container rear wall, particularly preferably made of metal.

5. The side panel according to claim 1, wherein the at least one collar has a substantially circular cross-section and/or the at least one collar extends completely over a material thickness of the sheet profile and/or the at least one collar is formed by material of the sheet profile in contact with material of the at least one front wall holder and/or the at least one rear wall holder.

6. The side panel according to claim 1, wherein the at least one collar extends at least in regions into and beyond at least one collar opening of the at least one front wall holder and/or the at least one rear wall holder, wherein it is preferably provided that a depth of the at least one collar is between 5% and 80%, particularly preferably between 10% and 50%, further particularly preferably between 20% and 30%, of a collar opening depth.

7. The side panel according to claim 1, wherein the sheet profile comprises a groove-shaped profiling, preferably with a substantially rectangular cross-section, on a side surface of the sheet profile, which profiling is designed to receive a container base.

8. The side panel according to claim 7, wherein the profiling comprises at least one fastening means, preferably in the form of at least one barb, particularly preferably with two prongs, for connecting the container base to the sheet profile and/or for securing the container base to the sheet profile, wherein it is preferably provided that the at least one fastening means is materially connected to the sheet profile and/or is punched out of the profiling and/or protrudes transversely into the profiling.

9. The side panel according to claim 1, wherein the at least one front wall holder and/or the at least one rear wall holder is designed in the form of a bracket for insertion into the sheet profile, preferably via a recess of the at least one front wall holder and/or the at least one rear wall holder, the recess corresponding to an optional profiling of the sheet profile.

10. The side panel according to claim 1, wherein at least one stabilizing element is provided, which is arranged, preferably in the longitudinal extension of the side panel centrally and/or completely, at least in regions within the sheet profile for increasing a rigidity and/or strength of the side panel, wherein it is preferably provided that the at least one stabilizing element can be inserted into the sheet profile via a recess of the at least one stabilizing element corresponding to an optional profiling of the sheet profile.

11. The side panel according to claim 1, wherein a width of the sheet profile is between 3 mm and 10 mm, preferably between 4 mm and 6 mm.

12. The side panel according to claim 1, wherein the at least one front wall holder and/or the sheet profile comprises at least one coupling device for direct coupling to a drawer rail, preferably without container rail.

13. An arrangement comprising:
at least one body rail with a lateral web for connecting the at least one body rail to a furniture body,
at least one, in particular cuboid-shaped, drawer rail with a further lateral web oriented substantially parallel to the lateral web in the use state of the arrangement, and
the side panel according to claim 1, wherein the at least one side panel is mounted displaceably relative to the at least one body rail via the at least one drawer rail.

14. The arrangement according to claim 13, wherein the at least one side panel, preferably the side surface of the sheet profile, in a state fastened to the at least one drawer rail, is arranged at least in regions directly between the lateral web and the further lateral web.

15. The arrangement according to claim 13, wherein the at least one drawer rail comprises a support surface, which is aligned substantially orthogonally to the further lateral web and preferably adjoins the further lateral web, for directly supporting a container base in the state of use of the arrangement, wherein it is preferably provided that the support surface is freely accessible in the vertical direction from above, particularly preferably at least in regions and/or in the region of a contacting area for the container base, in the state of use of the arrangement.

16. The arrangement according to claim 13, wherein exactly one sheet profile is provided for direct connection to the drawer rail and/or a container base.

17. The arrangement according to claim 13, wherein the at least one side panel is coupled to the at least one drawer rail by at least one coupling device of the sheet profile and/or of the at least one front wall holder directly by contact, preferably without container rails.

18. The arrangement according to claim 13, wherein the arrangement comprises at least one container base which contacts the sheet profile directly, preferably without container rails and/or via a groove-shaped profiling of a side surface of the sheet profile for receiving the at least one container base, wherein it is preferably provided that the at least one container base is secured to the sheet profile via at least one fastening means.

19. The arrangement according to claim 18, wherein the at least one container base is arranged substantially flush with the at least one drawer rail, wherein it is preferably provided that the at least one container base rests flat on the at least one drawer rail.

20. The arrangement according to claim 13, wherein the arrangement comprises at least one container rear wall which is arranged on the at least one rear wall holder.

21. The arrangement according to claim 13, wherein a force transmission in the case of preferably vertical and/or lateral loading of the arrangement in a state of use of the arrangement can be provided directly, preferably without container rails, between the at least one side panel, preferably the sheet profile and/or the at least one front wall holder and/or the at least one rear wall holder, and the at least one drawer rail.

22. A piece of furniture, in particular a drawer, comprising:
a furniture body, and the arrangement according to claim 13.

23. A method for producing a side panel according to claim 1, comprising the following steps, which are to be carried out in particular in chronological order:
the sheet profile and the at least one front wall holder and/or the at least one rear wall holder are provided, wherein the at least one front wall holder and/or the at least one rear wall holder and optionally at least one stabilizing element are inserted into the sheet profile of the side panel, and
the sheet profile is collared to the at least one front wall holder and/or to the at least one rear wall holder at at least one connection point by means of at least one collar.

24. The method according to claim 23, wherein, in a preparatory step at least one collar opening is introduced into the at least one front wall holder and/or the at least one rear wall holder, wherein the at least one collar is formed between a plastic of the at least one front wall holder and/or the at least one rear wall holder and a metal of the sheet profile, preferably with a substantially circular cross-section, wherein the at least one collar extends at least partially in the at least one collar opening of the at least one front wall holder and/or the at least one rear wall holder.

25. The method according to claim 23, wherein the at least one collar is introduced, preferably automatically, by at least one punch or pin, wherein it is preferably provided that the sheet profile is collared to the at least one front wall holder and/or to the at least one rear wall holder at multiple connection points by a collar, particularly preferably arranged on a side surface of the sheet profile and/or on an underside of the sheet profile located in a state of use of the side panel.

26. The method according to claim 24, wherein material of the sheet profile is pressed against the at least one collar opening so that a force-fitting connection along the at least one collar opening and/or a form-fitting connection orthogonal to the at least one collar opening is formed.
